(19) United States
(12) Patent Application Publication
(10) Pub. No.: US 2019/0310770 A1
(43) Pub. Date: Oct. 10, 2019

(54) AUTOMATIC DISPLAYS OF VIRTUAL INPUT DEVICES

(71) Applicant: Hewlett-Packard Development Company, L.P., Houston, TX (US)

(72) Inventor: Irwan Halim, Houston, TX (US)

(73) Assignee: Hewlett-Packard Development Company, L.P., Houston, TX (US)

(21) Appl. No.: 15/771,304

(22) PCT Filed: Feb. 1, 2016
(86) PCT No.: PCT/US2016/015974

§ 371 Date: Aug. 31, 2018

(51) Int. Cl. G06F 3/0488; G06F 9/451

(52) U.S. Cl. CPC G06F 3/04886; G06F 3/03543; G06F 9/451

(57) ABSTRACT

Example implementations relate to automatically displaying a virtual input device. For example, a non-transitory computer readable storage medium includes instructions that when executed cause a processor of a computing device to determine an active graphical control element displayed on a display of the computing device, where the active graphical control element includes an input element; determine whether the active graphical control element corresponds to a desktop application or a non-desktop application based on a property of the active graphical control element; in response to a determination that active graphical control element corresponds to the desktop application, monitor the input element; and automatically display a virtual input device on the display based on a particular type of input event associated with the input element.

### BACKGROUND

Some computing devices, such as smart phones, may receive input from a touch-sensitive display and a physical keyboard. Thus, a user of the computing device has different ways to provide input.

### BRIEF DESCRIPTION OF THE DRAWINGS

Some examples of the present application are described with respect to the following figures:

FIG. 1A illustrates a computing device to automatically display a virtual input device in a graphical control element associated with a desktop application, according to an example;

FIG. 1B illustrates displaying a virtual input device in a graphical control element associated with a desktop application, according to an example;

FIG. 1C illustrates removing a virtual input device from a graphical control element associated with a desktop application, according to an example;

FIG. 2 illustrates a computing device to automatically display a virtual input device in a graphical control element associated with a desktop application, according to an example;

FIG. 3 illustrates a computing device to automatically display a virtual input device in a graphical control element associated with a desktop application, according to an example; and

FIG. 4 illustrates a method of operation at a computing device to automatically display a virtual input device in a graphical control element associated with a desktop application.

### DETAILED DESCRIPTION

More and more computing devices have the capability to receive touch input besides smart phones. For example, all-in-one computers and tablet computers have touch-sensitive displays to receive touch inputs. An application (implemented using processor executable instructions) may take advantage of the capability by including a feature to automatically display a virtual input device, such as virtual keyboard, to receive touch input. An example of such an application may be a mobile application developed for a portable computing device, such as a smart phone. However, an application developed for a non-portable computing device, such as a desktop computer, may not have such a feature. A user of the application may have to manually search and activate a virtual input device. Thus, user experience of the application may be negatively affected.

Examples described herein provide a computing device to automatically display a virtual input device in a graphical control element associated with a desktop application. For example, a non-transitory computer readable storage medium may include instructions that when executed cause a processor of a computing device to determine an active graphical control element displayed on a display of the computing device. The active graphical control element may include an input element. The instructions when executed may further cause the processor to determine whether the active graphical control element corresponds to a desktop application or a non-desktop application based on a property of the active graphical control element. The instructions when executed may further cause the processor to, in response to a determination that active graphical control element corresponds to the desktop application, monitor the input element. The instructions when executed may further cause the processor to automatically display a virtual input device on the display based on a particular type of input event associated with the input element. Thus, user experience of the application may be enhanced.

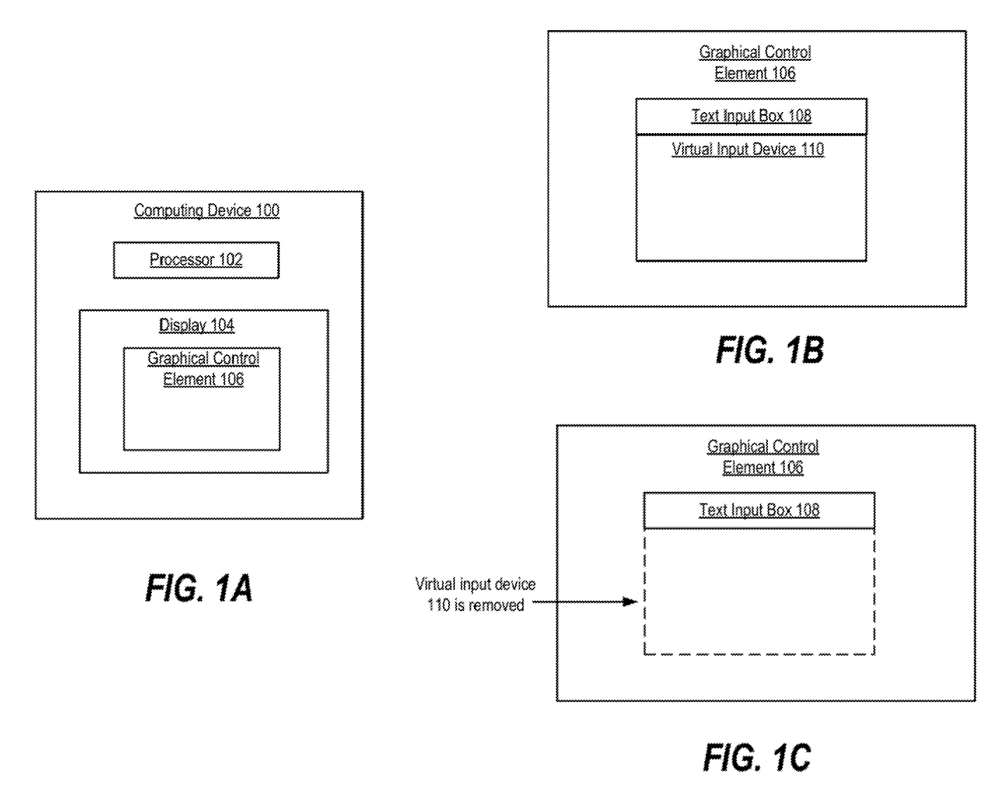

FIG. 1A illustrates a computing device 100 to automatically display a virtual input device in a graphical control element associated with a desktop application, according to an example. Computing device 100 may be, for example, a smart phone, a tablet computer, an all-in-one computer, a notebook computer, or any other electronic device suitable to receive input via touch inputs. Computing device 100 may include a processor 102 and a display 104.

Processor 102 may be a central processing unit (CPU), a semiconductor-based microprocessor, and/or other hardware devices suitable for retrieval and execution of instructions stored in a computer-readable storage medium. Processor 102 may fetch, decode, and execute instructions to control a process of automatically displaying a virtual input device in a graphical control element associated with a desktop application. Display 104 may be touch-sensitive display implemented using a touchscreen. For example, display 104 may be a touch-sensitive liquid crystal display (LCD). Processor 102 may control operations of computing device 100.

During operation, a graphical control element 106 may be launched and displayed on display 104. Graphical control element 106 may be an interaction component in a graphical user interface associated with an application (implemented using instructions executable by processor 102) that is executing at computing device 100. Graphical control element 106 may provide visual representation of data to a user and may receive input from the user. For example, graphical control element 106 may be implemented as a window in a graphical user interface.

When graphical control element 106 is displayed, processor 102 may detect the presence of graphical control element 106. Processor 102 may monitor graphical control element 106 to determine whether graphical control element 106 becomes active. Graphical control element 106 may become active when graphical control element 106 receives an interaction from a user input via an input device. For example, graphical control element 106 may become active when a user of computing device 100 clicks on graphical control element 106 via a mouse. As another example, graphical control element 106 may become active when the user touches graphical control element 106 via a stylus or a finger.

In response to a determination that graphical control element 106 is active, processor 102 may determine whether graphical control element 106 corresponds to a desktop application or a non-desktop application. That is, processor 102 may determine graphical control element 106 is part of a desktop application or a non-desktop application. As used herein, a desktop application may be an application that lacks the ability to automatically display a virtual input device. A non-desktop application may be an application that has the ability to automatically display a virtual input device.

Processor 102 may determine graphical control element 106 is part of a desktop application or a non-desktop application based on a property of graphical control element 106. In some examples, the property may be an indication of an executing operating system process that is associated with the graphical control element. For example, processor 102 may query an operating system of computing device 100 to determine whether graphical control element 106 is associated with an executing operating system process. In response to a determination that graphical control element 106 is associated with an executing operating system process, processor 102 may determine that graphical control element 106 corresponds to a desktop application.

In response to a determination that graphical control element 106 is not associated with any executing operating system process, processor 102 may determine that graphical control element 106 corresponds to a non-desktop application. In some examples, in response to a determination that graphical control element 106 is not associated with any executing operating system process, processor 102 may further query the operating system to determine w graphical control element 106 includes a particular class name that is indicative of a non-desktop application to ensure graphical control element 106 has the ability to automatically display a virtual input device. For example, the class name “Windows.UI.core.CoreWindow” may be indicative of a type of non-desktop application called Universal Windows Platform (UWP) application. When processor 102 determines that graphical control element 106 corresponds to a non-desktop application, processor 102 may stop monitoring graphical control element 106.

FIG. 1B illustrates displaying a virtual input device 110 in graphical control element 106 associated with a desktop application, according to an example. FIG. 1B may be described with reference to FIG. 1A. Graphical control element 106 may include a text input box 108. Text input box 108 may be an input element of graphical control element 106 to receive an input from a user. During operation, in response to a determination that graphical control element 106 corresponds to a desktop application, processor 102 may examine components of graphical control element 106 to identify text input box 108. For example, processor 102 may enumerate dialog items of graphical control element 106 and check the class name of each dialog item to identify text input box 108.

When text input box 108 is identified, processor 102 may monitor text input box 108 to detect a particular type of input event associated with text input box 108. When the user of computing device 100 selects text input box 108 to begin providing input, processor 102 may determine a type of input event associated with text input box 108. For example, when the user selects text input box 108 via a touch input, such as using a physically making contact with display 104 via a stylus or a finger, the type of input event may be a touch input event. When the user selects text input box 108 via a mouse, the type of input event may be a mouse click input event.

When the type of input event is the touch input event, processor 102 may cause virtual input device 110 to be automatically displayed on display 104 near text input box 108. As used herein, automatically displaying virtual input device 110 means virtual input device 110 is displayed without receiving an input from the user to launch a display of virtual input device 110. That is, the user does not have to select or execute another application to launch virtual input device 110. Virtual input device 110 may be any type of input device rendered or generated using processor executable instructions. In some examples, virtual input device 100 may be a virtual keyboard.

When the type of input event is the mouse click input event, processor 102 may determine whether a physical keyboard is available for use. For example, processor 102 may query the operating system to determine whether a physical keyboard is coupled to computing device 100. In response to a determination that the physical keyboard is unavailable for use (i.e., not coupled to computing device 100). Processor 102 may cause virtual input device 110 to be automatically displayed near text input box 108.

FIG. 1C illustrates removing virtual input device 110 from a graphical control element associated with a desktop application, according to an example. FIG. 1C is described with reference to FIGS. 1A-1B. After virtual input device 110 is displayed, processor 102 may continue to monitor text input box 108. Processor 102 may cause virtual input device 110 to be removed automatically from text input box 108 when the input event ends. For example, the input event may end when the user selects another graphical control element or another component of graphical control element 106. When virtual input device 110 is removed, virtual input device 110 is not displayed on display 104.

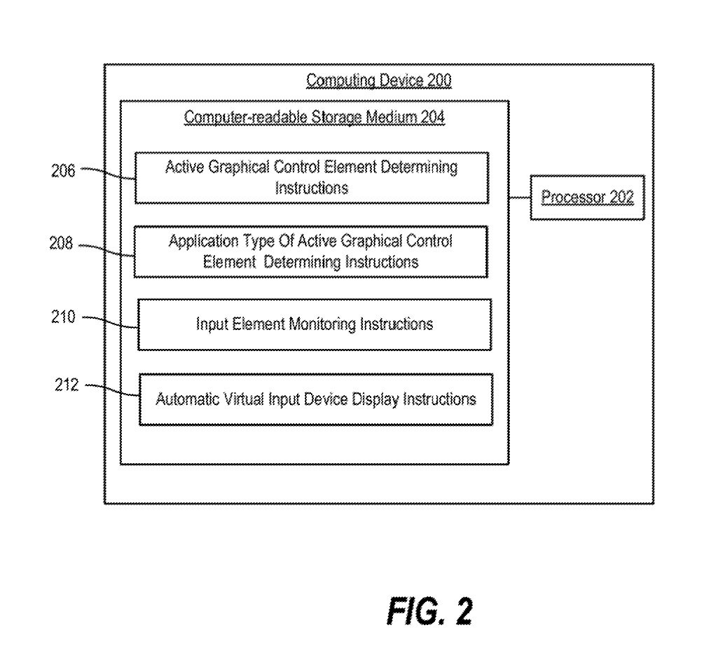

FIG. 2 illustrates a computing device 200 to automatically display a virtual input device in a graphical control element associated with a desktop application, according to an example. Computing device 200 may implement computing device 100 of FIG. 1A. Computing device 200 may include a processor 202 and a computer-readable storage medium 204.

Processor 202 may be similar to processor 102 of FIG. 1A. Processor 202 may fetch, decode, and execute instructions 206-212 to control a process of automatically displaying a virtual input device, such as virtual input device 110. As an alternative or in addition to retrieving and executing instructions, processor 202 may include at least one electronic circuit that includes electronic components for performing the functionality of instructions 206, 208, 210, 212, or a combination thereof.

Computer-readable storage medium 2104 may be any electronic, magnetic, optical, or other physical storage device that contains or stores executable instructions. Thus, computer-readable storage medium 204 may be, for example, Random Access Memory (RAM), an Electrically Erasable Programmable Read-Only Memory (EEPROM), a storage device, an optical disc, etc. In some examples, computer-readable storage medium 204 may be a non-transitory storage medium, where the term “non-transitory” does not encompass transitory propagating signals. As described in detail below, computer-readable storage medium 204 may be encoded with a series of processor executable instructions 206-212.

Active graphical control element determining instructions 206 may determine whether a graphical control element is active. For example, referring to FIG. 1A, processor 102 may monitor graphical control element 106 to determine whether graphical control element 106 becomes active.

Active graphical control element application type determining instructions 208 may determine whether the active graphical control element corresponds to a desktop application or a non-desktop application. For example, referring to FIG. 1A, in response to a determination that graphical control element 106 is active, processor 102 may determine whether graphical control element 106 corresponds to a desktop application or a non-desktop application.

Input element monitoring instructions 210 may monitor an input element to detect a particular type of input event associated with the input element. For example, referring to FIG. 1A, when text input box 108 is identified, processor 102 may monitor text input box 108 to detect a particular type of input event associated with text input box 108.

Automatic virtual input device displaying instructions 212 may automatically display a virtual input device. For example, referring to FIG. 1B, when the type of input event is the touch input event, processor 102 may cause virtual input device 110 to be automatically displayed on display 104 near text input box 108.

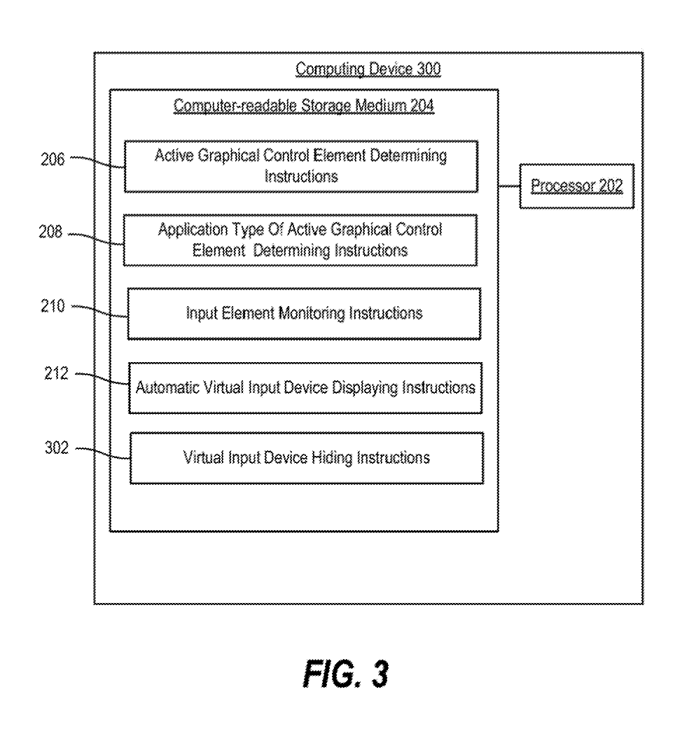

FIG. 3 illustrates a computing device 300 to automatically display a virtual input device in a graphical control element associated with a desktop application, according to an example. Computing device 300 may implement computing device 200 of FIG. 2. Computing device 300 may include processor 202 and computer-readable storage medium 204. Computer-readable storage medium 204 may be encoded with instructions 206-212 and 302. Automatic virtual input device removing instructions 302 may automatically remove a displayed virtual input device from a graphical control element. For example, referring to FIG. 1C, processor 102 may cause virtual input device 110 to be removed automatically from text input box 108 when the input event ends.

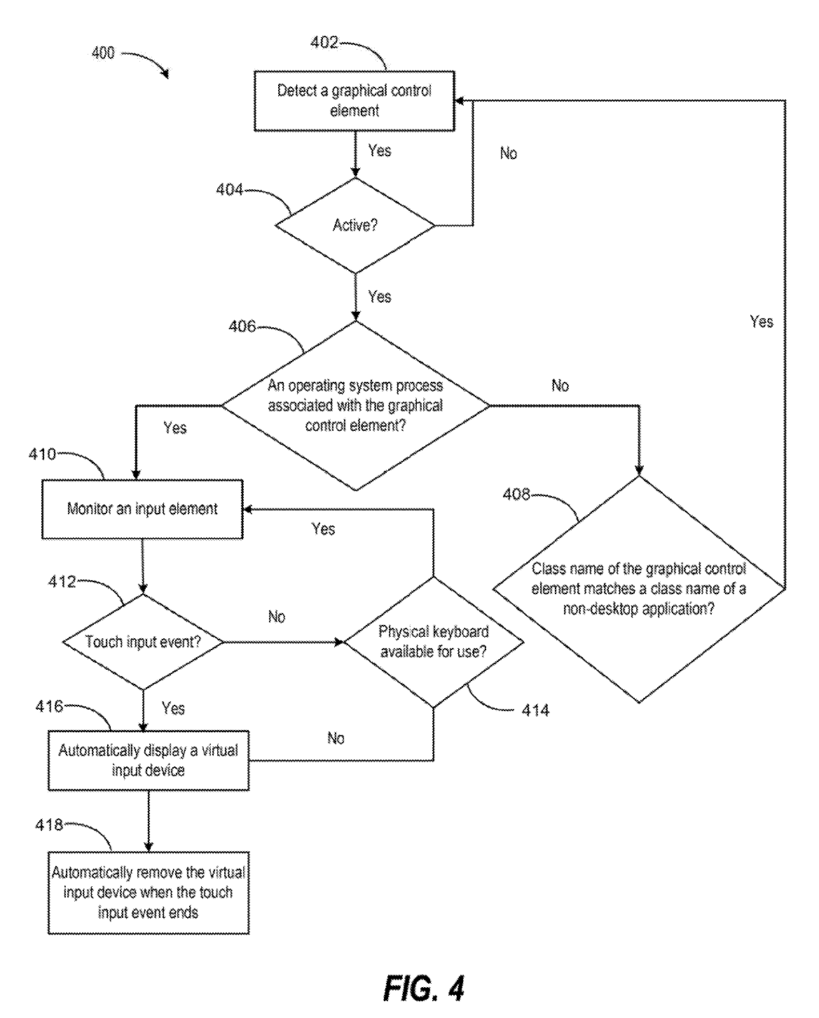

FIG. 4 illustrates a method 400 of operation at a computing device to automatically display a virtual input device in a graphical control element associated with a desktop application. Method 400 may be implemented using computing device 100 of FIG. 1 and/or computing device 200 of FIGS. 2-3.

Method 400 may include detecting a graphical control element, at 402. For example, referring to FIG. 1A, when graphical control element 106 is displayed, processor 102 may detect the presence of graphical control element 106. Method 400 may also include determining whether the graphical control element is active, at 404. For example, referring to FIG. 1A, processor 102 may monitor graphical control element 106 to determine whether graphical control element 106 becomes active. When the graphical control element is not active, method 400 may return to block 402. When the graphical control element is active, method 400 may further include determining whether there is an indication of an executing operating system process associated with the graphical control element, at 406. For example, referring to FIG. 1A, processor 102 may determine graphical control element 106 is part of a desktop application or a non-desktop application based on a property of graphical control element 106.

When there is not an indication of an executing operating system process associated with the active graphical control element, method 400 may further include determining whether a class name of the active graphical control element matches a class name of a non-desktop application, at 408. When the class name matches the class name of the non-desktop application, method 400 may return to block 402.

When there an indication of an executing operating system process associated with the active graphical control element, method 400 may further include monitoring an input element of the active graphical control element to detect a particular type of input event, at 410. For example, referring to FIG. 1A, during operation, in response to a determination that graphical control element 106 corresponds to a desktop application, processor 102 may examine components of graphical control element 106 to identify text input box 108.

Method 400 may further include determining if the input event is a touch input event, at 412. For example, referring to FIG. 1A, when the user of computing device 100 selects text input box 108 to begin providing input, processor 102 may determine a type of input event associated with text input box 108. When the input event is a mouse click input event instead of a touch input event, method 400 may further include determining if a physical keyboard is available for use at a computing device implementing method 400, such as computing device 100, at 414. When the physical keyboard is available for use, method 400 may return to block 410. When the physical keyboard is unavailable for use, method 400 may further include automatically displaying a virtual input device, at 416. Method 400 may further include automatically removing the virtual input device when the touch input event ends, at 418. For example, referring to FIG. 1A, processor 102 may cause virtual input device 110 to be removed automatically from text input box 108 when the input event ends.

The use of “comprising”, “including” or “having” are synonymous and variations thereof herein are meant to be inclusive or open-ended and do not exclude additional unrecited elements or method steps.

What is claimed is:

1. A non-transitory computer readable storage medium comprising instructions that when executed cause a processor of a computing device to:
determine an active graphical control element displayed on a display of the computing device, wherein the active graphical control element includes an input element;
determine whether the active graphical control element corresponds to a desktop application or a non-desktop application based on a property of the active graphical control element;
in response to a determination that active graphical control element corresponds to the desktop application, monitor the input element; and
automatically display a virtual input device on the display based on a particular type of input event associated with the input element.

2. The non-transitory computer-readable storage medium of claim 1, wherein the instructions when executed further cause the processor to:
automatically remove the virtual input device from the graphical control element when the particular type of input event ends.

3. The non-transitory computer-readable storage medium of claim 1, wherein the virtual input device corresponds to a virtual keyboard.

4. The non-transitory computer-readable storage medium of claim 1, wherein the instructions when executed further cause the processor to:
in response to the determination that active graphical control element corresponds to the desktop application, identify the input element from elements of the active graphical control element.

5. The non-transitory computer-readable storage medium of claim 1, wherein the particular type of input event includes a touch input event.

6. The non-transitory computer-readable storage medium of claim 1, wherein the property includes an indication of an executing operating system process that is associated with the active graphical control element.

7. The non-transitory computer-readable storage medium of claim 1, wherein the property includes a class name of the active graphical control element.

8. A non-transitory computer readable storage medium comprising instructions that when executed cause a processor of a computing device to:
determine an active graphical control element displayed on a display of the computing device, wherein the active graphical control element includes an input element;
determine whether the active graphical control element corresponds to a desktop application based on an indication of an executing operating system process that is associated with the active graphical control element;
in response to a determination that active graphical control element corresponds to the desktop application, monitor the input element; and
automatically display a virtual input device on the display based on a particular type of input event associated with the input element.

9. The non-transitory computer-readable storage medium of claim 8, wherein the instructions when executed further cause the processor to:
automatically remove the virtual input device from the graphical control element when the particular type of input event ends.

10. The non-transitory computer-readable storage medium fly wherein the virtual input device corresponds to a virtual keyboard.

11. The non-transitory computer-readable storage medium of claim wherein the particular type of input event includes a touch input event.

12. A computing device comprising:
a display to display a graphical control element, wherein the graphical control element includes an input element; and
a processor to:
in response to a determination that the graphical control element is active, determine whether the graphical control element corresponds to a desktop application or a non-desktop application based a property of the graphical control element;
in response to a determination that the graphical control element corresponds to the desktop application, monitor the input element to determine a type of input event associated with the input element, wherein the type of input event includes a touch input event and a mouse click input event; and
in response to a determination that the type of input event is the touch input event, automatically display a virtual input device on the display.

13. The computing device of claim 12, wherein the property includes an indication of an executing operating system process that is associated with the graphical control element.

14. The computing device of claim 13, wherein the property includes a class name of the graphical control element.

15. The computing device of claim 12, wherein the processor is further to:
in response to a determination that the type of input event is the mouse click input event, determine whether a physical keyboard is available for use; and
in response to a determination that the physical keyboard is unavailable, automatically display a virtual input device on the display.
